(19) United States
(12) Patent Application Publication
(10) Pub. No.: US 2011/0019568 A1
(43) Pub. Date: Jan. 27, 2011

(54) METHOD AND APPARATUS FOR TRANSMITTING AND RECEIVING DATA IN MOBILE COMMUNICATION SYSTEM

(75) Inventors: Soeng-Hun Kim, Suwon-si (KR); Himke Van Der Velde, Staines (GB)

Correspondence Address: Jefferson IP Law, LLP, 1130 Connecticut Ave., NW, Suite 420, Washington, DC, 20036, US

(73) Assignee: SAMSUNG ELECTRONICS CO. LTD., Suwon-si, Gyeonggi-do (KR)

(21) Appl. No.: 12/867,463

(22) PCT Filed: Feb. 13, 2009
(86) PCT No.: PCT/KR09/00712

§ 371 Date: Aug. 12, 2010

(30) Foreign Application Priority Data
Feb. 13, 2008 (KR) 10-2008-0013222

(51) Int. Cl. H04L 12/26; H04W 4/00

(52) U.S. Cl. 370/252; 370/328

(57) ABSTRACT

A method and apparatus for transmitting/receiving data in a mobile communication system is provided. The method includes, when a status report is not received after a predetermined time elapses since a polling Packet Data Unit (PDU) is initially transmitted, generating a Radio Link Control (RLC) PDU indicating retransmission of the initially transmitted polling PDU, and transmitting the RLC PDU indicating the retransmission of the initially transmitted polling PDU.

### PRIORITY

This application claims the benefit of a Korean patent application filed in the Korean Industrial Property Office on Feb. 13, 2008, and assigned Serial No. 10-2008-0013222, the entire of which is hereby incorporated by reference.

### BACKGROUND OF THE INVENTION

1. Field of the Invention

The present invention relates to a method and apparatus for transmitting/receiving data in a mobile communication system. More particularly, the present invention relates to a method and apparatus for retransmission of a polling packet data unit and status reporting corresponding thereto in a mobile communication system.

2. Description of the Related Art

As generally known in the art, a mobile communication system is technology to provide a user with a voice service while ensuring mobility. With the rapid development of mobile communication technology, mobile communication systems have evolved into a form that can provide a data service. Mobile communication systems capable of providing data services are broadly classified into a Code Division Multiple Access (CDMA) scheme in North America and a Universal Mobile Telecommunication Service (UMTS) scheme in Europe.

The UMTS mobile communication system is a 3^{rd} generation asynchronous mobile communication system which is based on European mobile communication systems, including Global System for Mobile Communications (GSM) and General Packet Radio Services (GPRS), and employs a Wideband CDMA (WCDMA) scheme.

Long Term Evolution (LTE) as the standard for an evolved mobile communication system of the UMTS system is now under discussion by the 3^{rd} Generation Partnership Project (3GPP) responsible for UMTS standardization. LTE with an aim of commercialization by around 2010 is technology for implementing high-speed packet-based communication of about 100 Mbps. To this end, various plans are being discussed, including a plan to reduce the number of nodes located on a communication path by simplifying a network architecture, a plan to approximate radio protocols to a radio channel as close as possible, and so forth.

FIG. 1 illustrates a configuration of an evolved mobile communication system based on the UMTS system according to the related art.

Referring to FIG. 1, each Evolved Radio Access Network (E-RAN) 110, 112 is simplified to a two-node configuration of evolved Node Bs (hereinafter referred individually to as “ENB” or “Node B”) 120, 122, 124, 126, 128 and evolved gateway GPRS serving nodes (EGGSN; hereinafter referred individually as “access gateway”) 130, 132, as illustrated therein. A User Equipment (UE) 101 accesses an Internet Protocol (IP) network 114 via the E-RANs 110, 112.

Each of the ENBs 120 to 128 corresponds to an existing Node B of the UMTS system, and is connected to the UE 101 over a radio channel. Unlike the existing Node B, each of the ENBs 120 to 128 performs more complex functions. In LTE, all user traffic, including real-time services such as a Voice over IP (VoIP) service, are serviced over a shared channel, and thus an apparatus for collecting situation information of UEs and performing scheduling depending thereon is needed. Each of the ENBs 120 to 128 serves as such an apparatus. In order to enable a maximum transmission speed of 100 Mbps, LTE uses an Orthogonal Frequency Division Multiplexing (OFDM) scheme as radio access technology with a bandwidth of 20 MHz. LTE also employs an Adaptive Modulation and Coding (AMC) scheme for determining a modulation scheme and a channel coding rate adaptive to the channel state of a UE.

FIG. 2 illustrates a radio protocol structure in an LTE mobile communication system according to the related art.

Referring to FIG. 2, on both sides of a UE and an ENB in an LTE system, a radio protocol includes a Packet Data Convergence Protocol (PDCP) 205, 240, a Radio Link Control (RLC) entity 210, 235, a Medium Access Control (MAC) layer 215, 230, and a Physical (PHY) layer 220, 225. The PDCP 205, 240 takes charge of IP header compression/decompression and other operations, and the RLC entity 210, 235 resizes a PDCP Packet Data Unit (PDU) to an appropriate size, and performs an Automatic Retransmission reQuest (ARQ) operation. A packet output from a specific protocol layer entity will be referred to herein as a PDU of the corresponding protocol. The MAC layer 215, 230 is connected to many RLC entities implemented in one terminal, and performs an operation of multiplexing RLC PDUs to a MAC PDU and demultiplexing a MAC PDU into RLC PDUs. The PHY layer 220, 225 performs an operation of channel-coding and modulating upper layer data into an OFDM symbol and transmitting the OFDM symbol over a radio channel, or an operation of demodulating and channel-decoding an OFDM symbol received over a radio channel and delivering the OFDM symbol to an upper layer.

When a receiver's RLC entity receives RLC PDUs generated by and transmitted from a counterpart RLC entity (i.e., a transmitter's RLC entity), the receiver's RLC entity generates a status report message on the received RLC PDUs (hereinafter referred to simply as “status report”) and transmits the status report to the transmitter's RLC entity if certain conditions are satisfied. The status report includes the sequence numbers of RLC PDUs that the receiver's RLC entity has normally received (hereinafter referred to as “ACK information”), and the sequence numbers of RLC PDUs that are required to be retransmitted because the receiver's RLC entity has not normally received them (hereinafter referred to as “NACK information”).

Certain conditions under which the status report is generated and transmitted include the case where a polling PDU is received from a counterpart RLC entity. Upon receiving a polling PDU from the transmitter's RLC entity, the receiver's RLC entity generates a status report and transmits the status report to the transmitter's RLC entity. For reference, the polling PDU refers to an RLC PDU, the header of which includes a polling bit set to “YES”.

With regard to a time when the receiver's RLC entity generates and transmits the status report, it is generally preferred to generate the status report after reordering of the sequence numbers of RLC PDUs for Hybrid Automatic Repeat reQuest (HARQ) is completed, rather than as soon as the receiver's RLC entity receives the polling PDU. Generally, a status report includes ACK information for the sequence number of an RLC PDU having the highest sequence number among RLC PDUs successfully received up to a corresponding time, and NACK information for the sequence numbers of unreceived RLC PDUs. For example, when RLC PDU Nos. 1 to 7 have been successfully received except RLC PDU Nos. 3 and 5 at a current point in time, a status report includes ACK information for RLC PDU No. 7 and NACK information for RLC PDU Nos. 3 and 5.

However, transmission of a status report including NACK information means a request for retransmission of corresponding RLC PDUs. Therefore, if NACK information for RLC PDUs currently being subjected to an HARQ process, is transmitted to the transmitter's RLC entity, then unnecessary retransmission may occur in the transmitter's RLC entity having received the NACK information.

In the above-mentioned example, RLC PDU No. 7 has been successfully received at the current point in time, but an error check for RLC PDU No. 5 is going on. In this situation, when the receiver's RLC entity determines that RLC PDU No. 5 has not been received, and transmits NACK information for RLC PDU No. 5 to the transmitter's RLC entity, the transmitter's RLC entity will retransmit RLC PDU No. 5 to the receiver's RLC entity, regardless of the error check for RLC PDU No. 5. However, if an RLC PDU has been actually received without any error, then there is no need to transmit the NACK information for RLC PDU No. 5 and retransmission corresponding thereto. Accordingly, upon receiving the polling PDU, the receiver's RLC entity generates the status report after completing a reordering of RLC PDUs with sequence numbers lower than that of the polling PDU.

In addition, the transmitter's RLC entity generates and transmits a polling PDU if given polling conditions are satisfied. In order to indicate that a transmitted RLC PDU is a polling PDU, the transmitter's RLC entity sets a polling bit, included in the header of an RLC PDU to be transmitted, to “YES”, and transmits the RLC PDU with the polling bit set to “YES”.

A typical condition under which the polling PDU is generated corresponds to the case where the transmitter's RLC entity transmits the last RLC PDU of RLC PDUs to be transmitted. When the transmitter's RLC entity transmits the last RLC PDU, the transmitter's RLC entity cannot use a normal ARQ procedure to determine if the receiver's RLC entity successfully receives the last RLC PDU. On account of this, the transmitter's RLC entity transmits the last RLC PDU with a polling bit set to “YES”, and then determines if transmission of the last RLC PDU is successful using a polling timer. The polling timer scheme will be described in detail with reference to FIG. 3.

FIG. 3 illustrates a signal flow of RLC PDU transmission/reception in a case where a polling timer is used according to the related art.

Referring to FIG. 3, in step 315, the transmitter's RLC entity 310 sets a polling bit of RLC PDU No. x to “YES”, and transmits the polling PDU to a receiver's RLC entity 305. If certain conditions are satisfied, for example, upon completion of transmission of the polling PDU, the transmitter's RLC entity 310 drives a polling timer for a given time in step 325. When transmission of the polling PDU is unsuccessful, or the receiver's RLC entity 305 properly receives the polling PDU but transmission of a status report 320 is unsuccessful, the transmitter's RLC entity 310 cannot receive the status report until the polling timer expires. If the transmitter's RLC entity 310 fails to receive the status report (i.e., a response to the polling PDU) until the polling timer expires, then the transmitter's RLC entity retransmits the polling PDU in step 330.

Since the polling PDU retransmitted in step 330 is transmitted to the receiver's RLC entity 305 after the set time of the polling timer elapses, a sufficient time more than the set time of the polling timer has elapsed when the receiver's RLC entity 305 receives the retransmitted polling PDU. Thus, even when there are RLC PDUs that the receiver's RLC entity 305 has not received among RLC PDUs with sequence numbers lower than that of the polling PDU, there is little possibility that the unreceived RLC PDUs are being subjected to an HARQ process in the receiver's RLC entity 305, and in most cases, reordering of the retransmitted polling PDU has probably been completed. Therefore, in order to generate a status report, the receiver may wait for the completion of reordering of the retransmitted polling PDU. However, this results in a problem in that the generation of the status report is delayed, and thus ARQ performance is lowered.

### SUMMARY OF THE INVENTION

An aspect of the present invention is to address the above-mentioned problems and/or disadvantages and to provide at least the advantages described below. Accordingly, an aspect of the present invention is to provide a method and apparatus capable of quickly reporting on the status of received RLC PDUs in a mobile communication system.

An additional aspect of the present invention provides a method and apparatus capable of enhancing ARQ performance in a mobile communication system.

An additional aspect of the present invention provides a method and apparatus capable of indicating a retransmitted polling PDU when a transmitter's entity transmits it.

An additional aspect of the present invention provides a method and apparatus allowing a receiver's entity to determine if a polling PDU is retransmitted and depending thereon, generate a status report at a different time.

In accordance with an aspect of the present invention, a method for transmitting data in a mobile communication system is provided. The method includes when a status report is not received after a predetermined time elapse since a polling Packet Data Unit (PDU) is initially transmitted, generating a Radio Link Control (RLC) PDU indicating retransmission of the initially transmitted polling PDU, and transmitting the RLC PDU indicating the retransmission of the initially transmitted polling PDU.

In accordance with another aspect of the present invention, a method for receiving data in a mobile communication system is provided. The method includes, when a Radio Link Control (RLC) Packet Data Unit (PDU) is received, determining whether the received RLC PDU is an RLC PDU indicating retransmission of an initially transmitted polling PDU, and when the received RLC PDU is determined to be the RLC PDU indicating the retransmission of the initially transmitted polling PDU, immediately generating and transmitting a reception status report In accordance with another aspect of the present invention, an apparatus for transmitting data in a mobile communication system is provided. The apparatus includes a transmission controller for, when a status report is not received after a predetermined time elapses since a polling Packet Data Unit (PDU) is initially transmitted, controlling the apparatus to generate a Radio Link Control (RLC) PDU indicating retransmission of the initially transmitted polling PDU, and a transmitter for transmitting the RLC PDU indicating the retransmission of the initially transmitted polling PDU under a control of the transmission controller.

In accordance with another aspect of the present invention, an apparatus for receiving data in a mobile communication system is provided. The apparatus includes a reception controller for, when a Radio Link Control (RLC) Packet Data Unit (PDU) is received, determining whether the received RLC PDU is an RLC PDU indicating retransmission of an initially transmitted polling PDU, and a status report processor for, when the received RLC PDU is determined to be the RLC PDU indicating the retransmission of the initially transmitted polling PDU, immediately generating and transmitting a reception status report.

In accordance with another aspect of the present invention, a method of improving Automatic Repeat reQuest (ARQ) performance in a mobile communication system is provided. The method includes determining whether a predetermined time set in a polling timer has expired, and when the predetermined timer has expired, generating a polling Packet Data Unit (PDU), the polling PDU having specific features identifying the polling PDU as a polling PDU for retransmission.

In accordance with another aspect of the present invention, a method of receiving a Packet Data Unit (PDU) in a mobile communication system is provided. The method includes receiving a PDU, determining whether the PDU is a retransmitted polling PDU based on a specific feature of the polling PDU, and when the PDU is determined to be a retransmitted polling PDU, immediately generating a reception status report based on the retransmitted polling PDU.

According to an exemplary embodiment of the present invention, the following advantageous effects can be obtained. When an RLC PDU corresponding to a polling PDU initially transmitted by a transmitter's RLC entity is retransmitted, information indicating retransmission of the polling PDU is included in the retransmitted RLC PDU, and thus a receiver's RLC entity receiving the RLC PDU is allowed to determine if the received RLC PDU corresponds to the retransmitted polling PDU. In this way, the receiver's RLC entity can immediately generate a status report, which reduces a delay time according to ARQ. Therefore, ARQ performance can be improved between the transmitter's and receiver's RLC entities.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a view illustrating a configuration of an LTE mobile communication system according to the related art;

FIG. 2 is a view illustrating a radio protocol structure in an LTE mobile communication system according to the related art;

FIG. 3 is a signal flowchart for explaining an operation of a poling timer according to the related art;

FIG. 4 is a flowchart for explaining a method for generating a polling PDU in a transmitter's RLC entity according to an exemplary embodiment of the present invention;

FIGS. 5A to 5D are views for explaining transmission formats capable of indicating retransmission of a polling PDU according to first to fourth exemplary embodiments of the present invention;

FIG. 6 is a flowchart for explaining a reception method in a receiver's RLC entity receiving a last segment, the payload of which has a size of 0, according to the first exemplary embodiment of present invention;

FIG. 7 is a flowchart for explaining a control flow in a receiver's RLC entity when a polling PDU is received according to the second exemplary embodiment of the present invention;

FIG. 8 is a flowchart for explaining a control flow in a receiver's RLC entity when a polling PDU is received according to the third exemplary embodiment of the present invention;

FIG. 9 is a flowchart for explaining a control flow in a receiver's RLC entity when a polling PDU is received according to the fourth exemplary embodiment of the present invention; and

FIG. 10 is a view illustrating an apparatus according to an exemplary embodiment of the present invention.

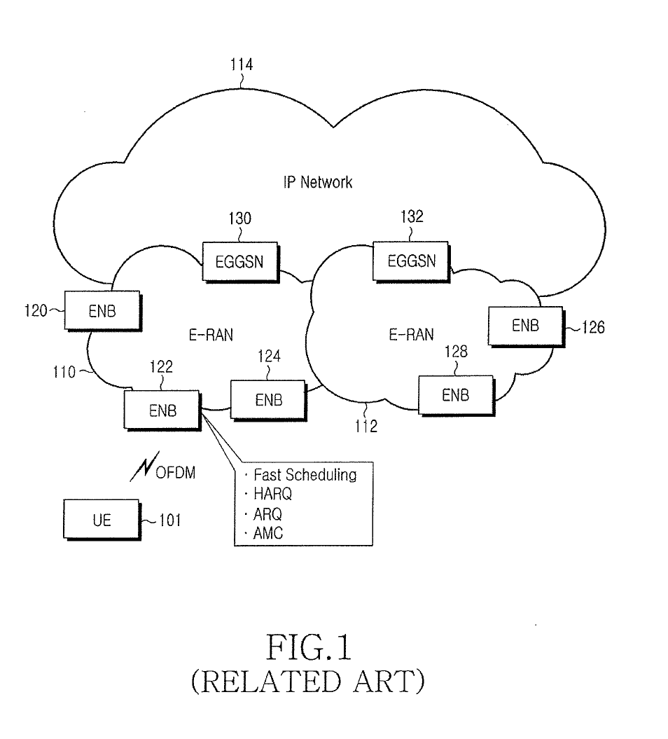

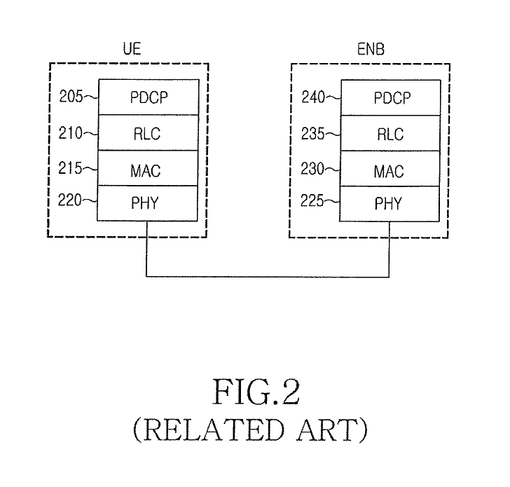

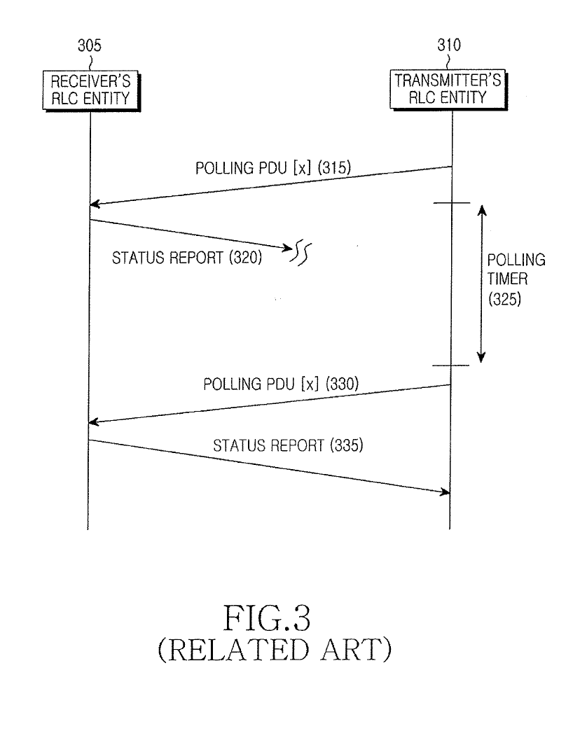

Throughout the drawings, it should be noted that like reference numbers are used to depict the same or similar elements, features and structures.

### DETAILED DESCRIPTION OF EXEMPLARY EMBODIMENTS

The following description with reference to the accompanying drawings is provided to assist in a comprehensive of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “and,” and “the” include plural referents unless the context clearly dictates otherwise. Thus, for example, reference to “a component structure” includes reference to one or more of such surfaces.

According to exemplary embodiments of the present invention, a transmitter's RLC entity generates and transmits a polling PDU in such a manner that a receiver's RLC entity can distinguish between a general polling PDU and a polling PDU retransmitted due to the expiration of a polling timer. For the general polling PDU, the receiver's RLC entity generates a status report after the completion of reordering. For the polling PDU retransmitted due to the expiration of the polling timer, the receiver's RLC entity generates a status report immediately without waiting for the completion of reordering.

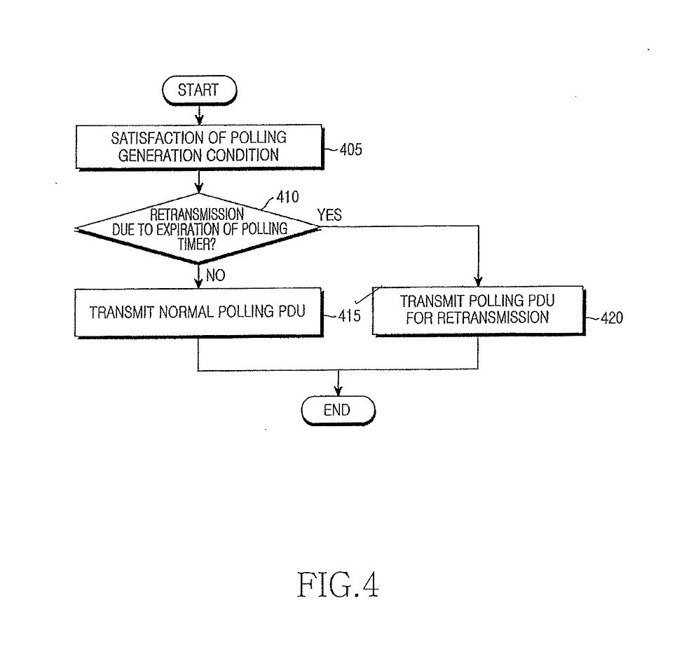

FIG. 4 is a flowchart for explaining a method for generating a polling PDU in a transmitter's entity according to an exemplary embodiment of the present invention. In the following description, it will be assumed that the transmitter's entity is a transmitter's RLC entity. However, it would be apparent to those skilled in the art that the same operation can be performed when the transmitter's RLC entity is replaced by or changed to any other specific entity using an ARQ scheme. For example, the polling PDU may contain a specific feature identifying the polling PDU as a retransmitted PDU.

Referring to FIG. 4, in step 405, when a polling generation condition is satisfied, the RLC entity proceeds to step 410. The polling generation conditions may include a case where:
<Condition 1> the RLC entity transmits a last RLC PDU of RLC PDUs to be transmitted;
<Condition 2> the RLC entity continuously transmits a predetermined number of RLC PDUs without setting their polling bits to “YES”; and
<Condition 3> a given time set in a polling timer expires.

In step 410, the RLC entity checks if the satisfied polling generation condition corresponds to <Condition 3>, the condition where a given time set in a polling timer expires. If the satisfied polling generation condition corresponds to <Condition 3>, then a polling PDU to be subsequently transmitted will be a retransmitted polling PDU. Thus, the RLC entity proceeds to step 420 when subsequently retransmitting a polling PDU due to the expiration of the polling timer, and proceeds to step 415 when subsequently transmitting a general polling PDU due to conditions other than <Condition 3>.

In step 415, the RLC entity generates a general polling PDU, and transmits the general polling PDU to a receiver's RLC entity. The RLC entity sets a polling bit included in the header of an RLC PDU to be transmitted to “YES”, and then transmits the RLC PDU to a receiver's RLC entity. In step 420, the RLC entity generates and transmits an RLC PDU of a specific format according to an exemplary embodiment of the present invention so as to indicate that the transmitted RLC PDU corresponds to a retransmitted polling PDU.

Four exemplary embodiments of indicating the retransmitted polling PDU are described herein. Of course, the same result may be achieved by various ways other than the four below-described exemplary embodiments, so long as it is possible to indicate that a currently transmitted RLC PDU corresponds to a retransmitted polling PDU. The exemplary embodiments for indicating a retransmitted polling PDU include:
a first exemplary embodiment employing a format in which the payload size of the last segment is set to 0 when an initially transmitted polling PDU is retransmitted using a division and retransmission scheme;
a second exemplary embodiment employing a format in which the payload size of the first segment is set to 0 when an initially transmitted polling PDU is retransmitted using a division and retransmission scheme;
a third exemplary embodiment employing a format in which a separate RLC control PDU including polling information is generated; and
a fourth exemplary embodiment employing a format in which a polling PDU is configured in such a manner as to include only a header.

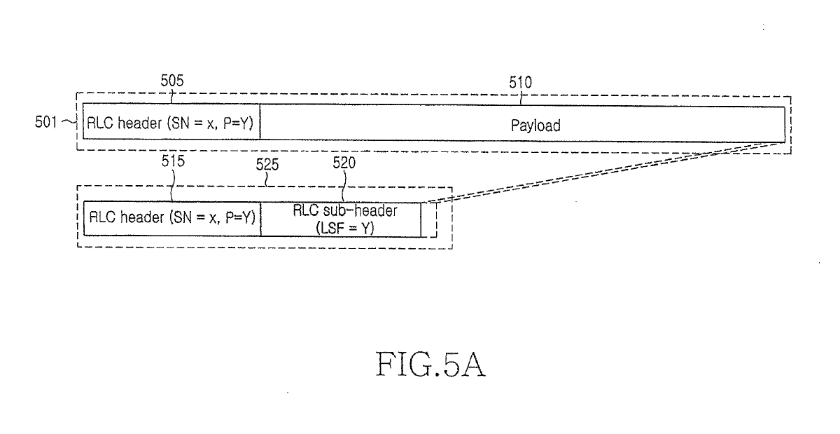

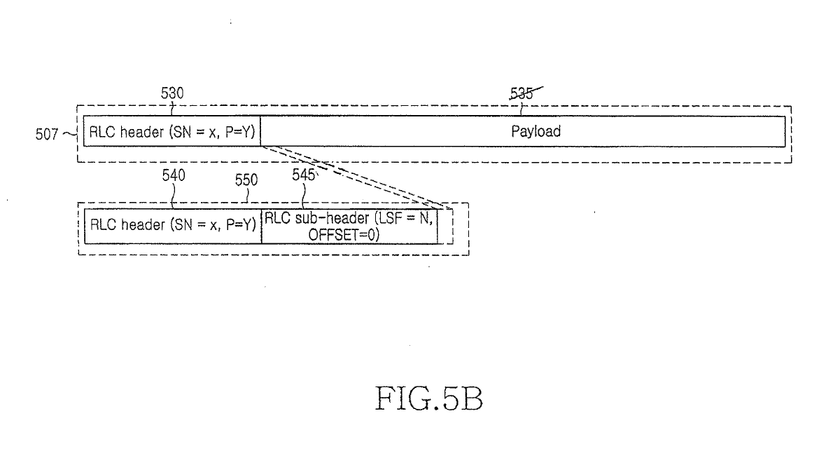

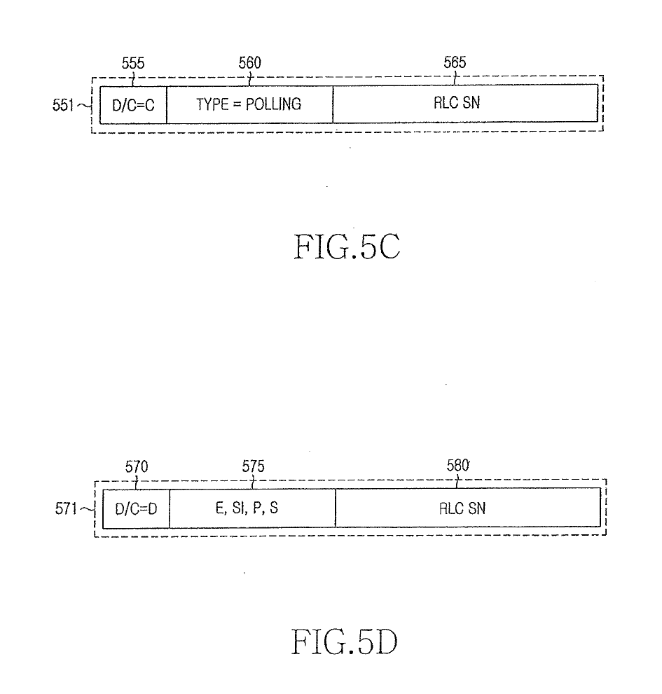

FIGS. 5A to 5D are views for explaining transmission formats capable of indicating a retransmitted polling PDU according to the first to fourth exemplary embodiments of the present invention.

FIGS. 5A and 5B illustrate transmission formats according to the first and second exemplary embodiments of the present invention. The first and second exemplary embodiments are common in that they both use a division and retransmission scheme to retransmit an initially transmitted polling PDU. The division and retransmission scheme will be briefly described below.

In an LTE system, the size of an RLC PDU may be diversely set depending on channel conditions and the like at the time the RLC PDU is transmitted. When the size of an RLC PDU cannot be applied at its retransmission, it is possible to divide the RLC PDU into a given number of retransmission RLC PDUs with an appropriate size, and retransmit the divided retransmission RLC PDUs. This is referred to as the division and retransmission scheme.

In the division and retransmission scheme, each divided retransmission RLC PDU is referred to as a segment. For example, assuming that an initially transmitted RLC PDU is divided into three retransmission RLC PDUs, the payload of the initially transmitted RLC PDU is divided and included in each of the three retransmission RLC PDUs, and the retransmission RLC PDUs can be referred to as segment No. 1, segment No. 2, and segment No. 3 respectively in that order.

In order to indicate information on the relation between the payload included in a corresponding retransmission RLC PDU and the payload of the initially transmitted RLC PDU, a division sub-header is inserted between the header and the payload of each retransmission RLC PDU. The division sub-header includes an offset field and a Last Segment Indicator (LSI) field. The offset field is information indicating what number byte of the initially transmitted RLC PDU payload is the first byte of a corresponding retransmission RLC PDU payload. The LSI field is information indicating if a corresponding retransmission RLC PDU is the last segment for the initially transmitted PDU, and typically has a size of 1 bit.

Since the payload of the initially transmitted RLC PDU is divided into the payloads of the retransmission RLC PDUs, it is common that they have a certain size. Thus, generally there is not a case where the payload of a retransmission RLC PDU has a size of 0 bytes. In view of this, the payload of a specific segment number is set to a size of 0 bytes in the first and second exemplary embodiments. In this way, when the payload of a predetermined segment number has a size of 0 bytes, a receiver's RLC entity can know that this segment corresponds to a retransmitted polling PDU.

FIG. 5A illustrates the first exemplary embodiment in which the payload of the last segment is set to a size of 0, and FIG. 5B illustrates the second exemplary embodiment in which the payload of the first segment is set to a size of 0.

Referring to FIG. 5A, reference numeral “501” designates an initially transmitted RLC PDU, and reference numeral “525” designates the last segment for retransmission of the initially transmitted RLC PDU 501. The payload of the last segment 525 is set to a size of 0, which is represented by the dotted line behind the RLC division sub-header 520 of the last segment 525. In the last segment 525, the RLC header 505 of the initially transmitted RLC PDU 501 is used as the RLC header 515 in its entirety, and the offset of the RLC division sub-header 520 is set to the same value as the size of the payload 510 of the initially transmitted RLC PDU 501. In addition, the LSI of the RLC division sub-header 520 is set to a value of “Y (YES)”, thereby indicating that the corresponding segment is the last segment.

In FIG. 5B, reference numeral “507” designates an initially transmitted RLC PDU, and reference numeral “550” designates the first segment for retransmission of the initially transmitted RLC PDU 507. In the first segment 550, the RLC header 530 of the initially transmitted RLC PDU 507 is used as the RLC header 540 in its entirety, the offset of the RLC division sub-header 545 is set to a value of 0, and the LSI of the RLC division sub-header 545 is set to a value of “N (NO)”.

Although the payloads of the last and first segments are set to a size of 0 respectively in the first and second exemplary embodiments, it is apparent to those skilled in the art that it is also possible to set the payload of any other segment number to a size of 0.

FIG. 5C illustrates a way to generate a separate RLC control PDU including polling information according to the third exemplary embodiment of the present invention. The polling information refers to information instructing a terminal to generate and transmits a status report.

The header of the RLC control PDU 551 including polling information according to the third exemplary embodiment of the present invention is configured in such a manner as to include a first bit 555, a type field 560, and a Sequence Number (SN) field 565. The first bit 555 corresponds to information indicating whether the corresponding RLC PDU is a data PDU or a control PDU, and is set to a value indicative of a control PDU. The type field 560 corresponds to information indicating the type of the corresponding RLC PDU, and is set to a value indicative of an RLC control PDU. The SN field 565 corresponds to information indicating the highest RLC PDU sequence number among a sequence of RLC PDUs on which a status report is required.

FIG. 5D illustrates a way to configure an RLC PDU for polling retransmission in such a manner as to include only an RLC header according to the fourth exemplary embodiment of the present invention. An RLC PDU for polling retransmission is configured in such a manner as to include only an RLC header and not to include a payload. The first bit 570 of the RLC PDU 571 including only an RLC header is set to a value indicative of a data PDU. Other header fields 575 of the RLC PDU 570, such as a polling bit P and an extension bit E, are set to appropriate values, and the RLC SN field 580 of the RLC PDU 571 is set to the SN value of the RLC PDU at its initial transmission. Subsequently, if a payload is not further added to the RLC PDU 571, the RLC PDU 571 for polling retransmission, including only an RLC header, is configured.

Generally, the overall length of a polling PDU can be discovered through a MAC header. When information included in the MAC header and indicating the length of the RLC PDU 571 is set to the same value as the length of the RLC header, a receiver's RLC entity can recognize that the RLC PDU includes no payload, and thus corresponds to an RLC PDU for polling retransmission, including only an RLC header. Since the RLC PDU for polling retransmission, including only an RLC header, does not normally occur at all, the RLC PDU including only an RLC header can be limited to polling retransmission.

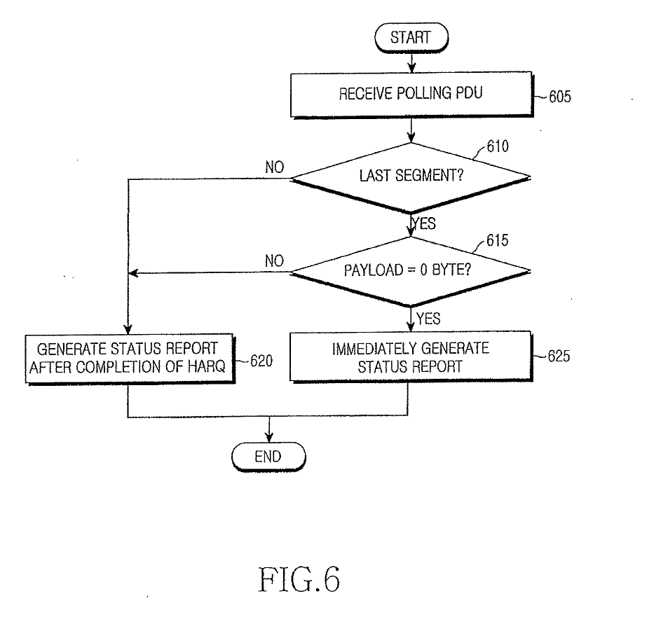

FIG. 6 illustrates a flowchart for explaining a reception method in a receiver's RLC entity receiving a last segment, the payload of which has a size of 0, according to the first exemplary embodiment of present invention.

Referring to FIG. 6, in step 605, upon receiving an RLC PDU with the polling bit set to “YES”, the receiver's RLC entity proceeds to step 610. In step 610, the RLC entity determines whether the received RLC PDU corresponds to the last segment of divided and retransmitted RLC PDUs (i.e., segments) of any RLC PDU. When the received RLC PDU includes a division sub-header, and the LSI of the division sub-header is set to “Y”, the RLC entity proceeds to step 615. However, when either of these two conditions is not satisfied, the RLC entity proceeds to step 620.

In step 615, the RLC entity determines whether the RLC PDU includes a payload. The RLC entity determines whether there is a remaining part when all RLC headers including a division sub-header are removed from an RLC PDU transferred from a lower layer. When there is a remaining part, this indicates that a payload exists in the RLC PDU and the size of the payload is not 0 bytes, and thus the RLC entity proceeds to step 620. However, when there is no remaining part, this indicates that the size of a payload is 0 bytes, and thus the RLC entity proceeds to step 625.

The RLC entity's proceeding to step 620 indicates that the received RLC PDU does not correspond to a last segment having a payload size of 0 bytes, and thus is not an RLC PDU retransmitted due to the expiration of a polling timer. The RLC entity therefore processes the RLC PDU according to a normal procedure. The normal procedure refers to a procedure in which a status report is generated and transmitted after HARQ reordering for RLC PDUs with sequence numbers lower than that of the received RLC PDU is completed. For reference, the status report may be generated at the time when the status report is ready to be transmitted, that is, a transmission resource for the status report is allocated.

The RLC entity's proceeding to step 625 indicates that the received RLC PDU corresponds to a last segment having a payload size of 0 bytes, and thus is an RLC PDU retransmitted due to the expiration of a polling timer. Accordingly, the RLC entity generates and transmits a status report immediately upon receiving the RLC PDU, without taking account of whether or not HARQ reordering is completed. For reference, the status report may be generated at the time when the status report is ready to be transmitted, that is, a transmission resource for the status report is allocated.

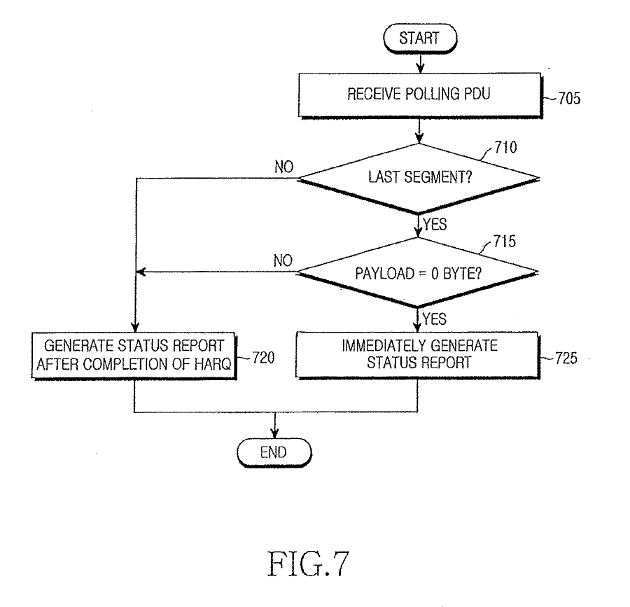

FIG. 7 illustrates a flowchart for explaining a control flow in a receiver's RLC entity when an RLC PDU is received according to the second exemplary embodiment of the present invention. FIG. 7 explains an operation of a receiver's RLC entity receiving a first segment having a polling bit set to “YES” and a payload size of 0 bytes.

Referring to FIG. 7, upon receiving an RLC PDU having a polling bit set to “YES”, in step 705, the receiver's RLC entity determines in step 710 whether the received RLC PDU corresponds to the first segment of divided and retransmitted RLC PDUs (i.e., segments) of any RLC PDU. When the received RLC PDU includes a division sub-header having an LSI set to “NO”, and an offset set to a value of 0, the RLC entity proceeds to step 715. However, when any one of these three conditions is not satisfied, the RLC entity proceeds to step 720.

In step 715, the RLC entity determines whether the RLC PDU includes a payload. The RLC entity determines whether there is a remaining part when all RLC headers including a division sub-header are removed from an RLC PDU transferred from a lower layer. When there is a remaining part, this indicates that the size of a payload is not 0 bytes, and thus the RLC entity proceeds to step 720. However, when there is no remaining part, this indicates that the size of a payload is 0 bytes, and thus the RLC entity proceeds to step 725.

The RLC entity's proceeding to step 720 indicates that the received RLC PDU does not correspond to a first segment having a payload size of 0 bytes, and thus is not an RLC PDU retransmitted due to the expiration of a polling timer. Accordingly, the RLC entity processes the RLC PDU according to a normal procedure. The RLC entity generates and transmits a status report after HARQ reordering for RLC PDUs with sequence numbers lower than that of the received RLC PDU is completed. For reference, the status report may be generated at the time when the status report is ready to be transmitted, that is, when a transmission resource for the status report is allocated.

The RLC entity's proceeding to step 725 indicates that the received RLC PDU corresponds to a first segment, having a payload size of 0 bytes, and thus is an RLC PDU retransmitted due to the expiration of a polling timer. Accordingly, the RLC entity generates and transmits a status report immediately after receiving a last segment.

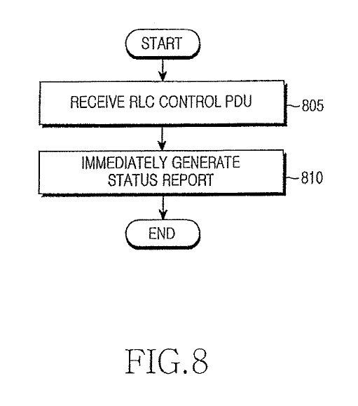

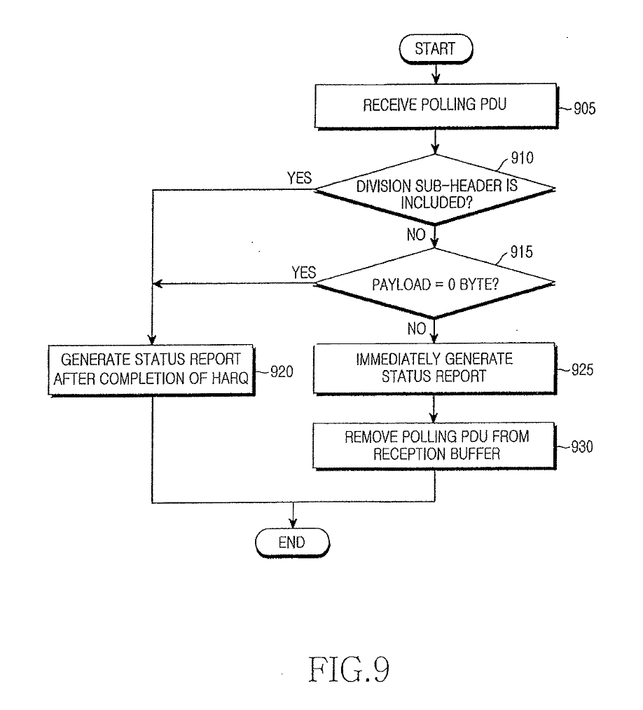

FIG. 8 illustrates a flowchart for explaining a control flow in a receiver's RLC entity when an RLC PDU is received according to the third exemplary embodiment of the present invention.

Referring to FIG. 8, in step 805, the receiver's RLC entity receives an RLC control PDU. Receiving an RLC control PDU indicates that the RLC header of the received RLC PDU includes a specific bit, for example the first bit, set to a predetermined value indicative of a control PDU, and subsequent fields including type information indicative of a PDU for polling retransmission and information indicating the highest RLC sequence number among a sequence of RLC PDUs on which a reception status report is required.

In step 810, upon receiving the RLC control PDU, the RLC entity immediately generates a status report. The generated status report includes ACK or NACK information for RLC PDUs corresponding to the sequence number included in the RLC control PDU. When the RLC entity successfully receives all RLC PDUs corresponding to the sequence number, the RLC entity includes ACK information for the received highest RLC PDU sequence number in the generated status report. When the RLC entity does not receive all RLC PDUs corresponding to the sequence number, the RLC entity includes NACK information for the unreceived highest RLC PDU sequence number in the generated status report. When the RLC entity successfully receives only a part of RLC PDUs corresponding to the sequence number, the RLC entity includes NACK information for all the unreceived RLC PDU sequence numbers in the generated status report.

FIG. 9 illustrates a flowchart for explaining a control flow in a receiver's RLC entity when an RLC PDU is received according to the fourth exemplary embodiment of the present invention.

Referring to FIG. 9, upon receiving an RLC PDU having a polling bit set to “YES” in step 905, the receiver's RLC entity determines in step 910 whether the received RLC PDU is a divided and retransmitted RLC PDU of any RLC PDU. When the received RLC PDU is a divided and retransmitted RLC PDU, that is, the received RLC PDU includes a division sub-header, the RLC entity proceeds to step 920. However, when the received RLC PDU does not include a division sub-header, the RLC entity proceeds to step 915.

In step 915, the RLC entity determines whether the RLC PDU includes a payload. That is, the RLC entity determines whether there is a remaining part when an RLC header is removed from an RLC PDU transferred from a lower layer. When there is a remaining part, this indicates that the size of the payload is not 0 bytes, and thus the RLC entity proceeds to step 920. However, when there is no remaining part, this indicates that the size of a payload is 0 bytes, and thus the RLC entity proceeds to step 925.

The RLC entity's proceeding to step 920 indicates that the received RLC PDU is a normal RLC PDU. Accordingly, the RLC entity processes the RLC PDU according to a normal procedure. The RLC entity generates and transmits a status report after HARQ reordering for RLC PDUs with sequence numbers lower than that of the received RLC PDU is completed. For reference, the status report may be generated at the time when the status report is ready to be transmitted, that is, a transmission resource for the status report is allocated.

The RLC entity's proceeding to step 925 indicates that the received RLC PDU corresponds to an RLC PDU including only an RLC header, and thus is an RLC PDU for polling retransmission, retransmitted due to the expiration of a polling timer. Accordingly, the RLC entity generates and transmits a status report immediately after receiving the RLC PDU, even when HARQ reordering for some of RLC PDUs with sequence numbers lower than that of the received RLC PDU is not completed. For reference, the status report may be generated at the time when the status report is ready to be transmitted, that is, a transmission resource for the status report is allocated.

Subsequently, in step 930, the RLC entity removes the RLC PDU including only an RLC header from a reception buffer. This permits the RLC entity to receive a normal RLC PDU with the same sequence number later on.

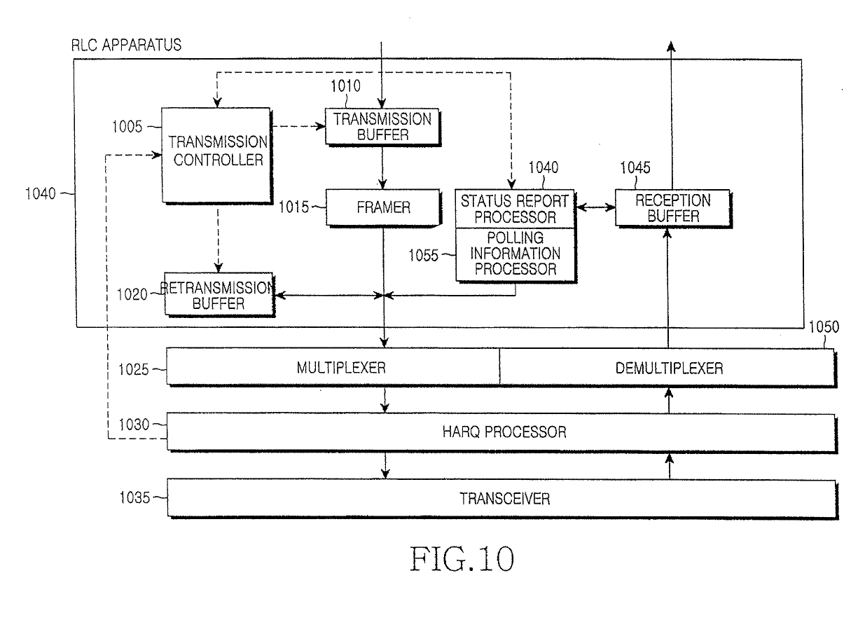

FIG. 10 illustrates an internal structure of an RLC apparatus according to an exemplary embodiment of the present invention.

Referring to FIG. 10, the RLC apparatus 1040 includes a transmission controller 1005, a transmission buffer 1010, a framer 1015, a retransmission buffer 1020, a status report processor 1040, a reception buffer 1045, and a polling information processor 1055. The RLC apparatus may also include additional units, which may correspond to particular functions of the RLC apparatus. Similarly, the functionality of two or more of the above units may be integrated into a single component.

In addition, the RLC apparatus is connected to a multiplexer 1025 and a demultiplexer 1050. The multiplexer 1025 multiplexes RLC PDUs transferred from a plurality of RLC apparatuses to one HARQ packet. The demultiplexer 1050 demultiplexes an HARQ packet transferred from an HARQ processor 1030 into RLC PDUs, and delivers the RLC PDUs to appropriate RLC apparatuses. The HARQ processor 1030 is a device for transmitting/receiving a HARQ packet through a prescribed HARQ operation, and a transceiver 1035 is a device for modulating an HARQ into a radio signal, transmitting the modulated radio signal, and demodulating the transmitted radio signal.

Reference will now be made in detail to an internal operation of the RLC apparatus 1040. Data transferred from an upper layer is stored in the transmission buffer 1010, and subsequently is framed to an appropriate size and is transmitted under the control of the transmission controller 1005. The transmission controller 1005 informs a lower layer of the amount of data to be transmitted, receives information on the amount of data to be transmitted in the next transmission period from the lower layer, and determines the data to be transmitted in the next transmission period based on the amount of data to be transmitted. The amount of data to be transmitted covers the total amount including the amount of data stored in the transmission buffer 1010, the amount of data stored in the retransmission buffer 1020, and the size of other control information, such as a status report.

Upon receiving a polling PDU, the transmission controller 1005 controls the status report processor 1040 to generate a status report at an appropriate time according to the type of the received polling PDU. For example, when a normal polling PDU is received, the transmission controller 1005 controls the status report processor 1040 to generate a status report after HARQ reordering for all RLC PDUs with sequence numbers lower than that of the polling PDU is completed.

In another example, when a last segment having a payload size of 0 bytes is received, and the polling bit of the last segment is set to “YES”, as in the first exemplary embodiment of the present invention, the transmission controller 1005 controls the status report processor 1040 to immediately generate a status report. In another example, when a first segment having a payload size of 0 bytes is received, and the polling bit of the first segment is set to “YES”, as in the second exemplary embodiment of the present invention, the transmission controller 1005 controls the status report processor 1040 to immediately generate a status report.

In another example, when an RLC control PDU including polling information is received as in the third exemplary embodiment of the present invention, the transmission controller 1005 controls the status report processor 1040 to immediately generate a status report in consideration of RLC PDUs stored in the reception buffer 1045. The transmission controller 1005 controls the status report processor 1040 to generate the status report such that ACK/NACK information for RLC PDUs corresponding to a sequence number contained in the RLC control PDU is included in the generated status report.

In another example, when an RLC PDU, which includes only an RLC header having a polling bit set to “YES”, is received as in the fourth exemplary embodiment of the present invention, the transmission controller 1005 controls the status report processor 1040 to immediately generate a status report in consideration of RLC PDUs stored in the reception buffer 1045. The transmission controller 1005 controls the status report processor 140 to generate the status report such that ACK/NACK information for the polling PDU including only an RLC header is included in the generated status report. The transmission controller 1005 also controls the reception buffer 1045 to remove the polling PDU including only an RLC header therefrom.

In addition, when the transmission controller 1005 operates in order to retransmit a PDU for polling retransmission, the transmission controller 1005 configures an RLC PDU in a predetermined format and retransmits the configured RLC PDU if retransmission of the PDU is due to the expiration of a polling timer. For example, the transmission controller 1005 configures an RLC PDU or segments of an RLC PDU according to any of the above-mentioned exemplary embodiments, and transmits the configured RLC PDU or RLC PDU segment.

The framer 1015 generates an RLC PDU by attaching an RLC header to data transferred from the transmission buffer 1010. The generated RLC PDU is transferred to the multiplexer 1025, and simultaneously is stored in the retransmission buffer 1020. The RLC PDU stored in the retransmission buffer 1020 is retransmitted at the request of a counterpart RLC apparatus, or is removed from the retransmission buffer 1020 if its successful transmission is confirmed.

The polling information processor 1055 sets the polling bit of an RLC PDU to “Y (YES)” if given conditions are satisfied. An RLC PDU transferred from the demultiplexer 1050 is stored in the reception buffer 1045. If given status reporting conditions are satisfied, the status report processor 1040 reports to the transmission controller 1005 that a status report is to be transmitted. When the transmission controller 1005 instructs the status report processor 1040 to transmit a status report, the status report processor 1040 checks the sequence numbers of RLC PDUs stored in the reception buffer 1045 to thereby recognize the sequence numbers of successfully received RLC PDUs and the sequence numbers of RLC PDUs for which to make a retransmission request, and configures a status report accordingly. The status report processor 1040 transmits the configured status report to a counterpart RLC apparatus.

While the invention has been shown and described with reference to certain exemplary embodiments thereof, it will be understood by those skilled in the art that various changes in form and details may be made therein without departing from the spirit and scope of the invention as defined by the claims and their equivalents.

1. A method for transmitting data in a mobile communication system, the method comprising:
when a status report is not received after a predetermined time elapses since a polling Packet Data Unit (PDU) is initially transmitted, generating a Radio Link Control (RLC) PDU indicating retransmission of the initially transmitted polling PDU; and
transmitting the RLC PDU indicating the retransmission of the initially transmitted polling PDU.

2. The method as claimed in claim 1, wherein the generating of the RLC PDU indicating the retransmission of the initially transmitted polling PDU comprises:
dividing the initially transmitted polling PDU into a given number of segments for retransmission, and setting a payload size of a segment of the divided segments to 0; and
setting the segment the payload size of 0 as the RLC PDU indicating the retransmission of the initially transmitted polling PDU.

3. The method as claimed in claim 2, wherein the segment having the payload size of 0 comprises a first segment or a last segment of the given number of segments.

4. The method as claimed in claim 1, wherein the generating of the RLC PDU indicating the retransmission of the initially transmitted polling PDU comprises generating an RLC control PDU that includes information indicating a PDU for control information transmission and information indicating the retransmission of the initially transmitted polling PDU.

5. The method as claimed in claim 1, wherein the generating of the RLC PDU indicating the retransmission of the initially transmitted polling PDU comprises generating the RLC PDU indicating the retransmission of the initially transmitted polling PDU in such a manner as to include only an RLC header.

6. A method for receiving data in a mobile communication system, the method comprising:
when a Radio Link Control Packet Data Unit (RLC PDU) is received, determining whether the received RLC PDU is an RLC PDU indicating retransmission of an initially transmitted polling PDU; and
when the received RLC PDU is determined to be the RLC PDU indicating the retransmission of the initially transmitted polling PDU, immediately generating and transmitting a reception status report.

7. The method as claimed in claim 6, wherein the
determining of whether the received RLC PDU is the RLC PDU indicating the retransmission of the initially transmitted polling PDU comprises:
determining whether the received RLC PDU belongs to a given number of segments for retransmission, into which the initially transmitted polling PDU is divided, and whether a payload size of a segment of the divided segments is set to a size of 0; and
determining whether the segment having the payload size of 0 is set to the RLC PDU indicating the retransmission of the initially transmitted polling PDU.

8. The method as claimed in claim 7, wherein the segment having the payload size of 0 comprises a first segment or a last segment of the given number of segments.

9. The method as claimed in claim 6, wherein the determining of whether the received RLC PDU is the RLC PDU indicating the retransmission of the initially transmitted polling PDU comprises determining whether the received RLC PDU is an RLC control PDU that includes information indicating a PDU for control information transmission and information indicating the retransmission of the initially transmitted polling PDU.

10. The method as claimed in claim 6, wherein the
determining of whether the received RLC PDU is the RLC PDU indicating the retransmission of the initially transmitted polling PDU comprises:
determining whether the received RLC PDU includes only an RLC header; and
determining whether the RLC header includes information indicating the retransmission of the initially transmitted polling PDU.

11. An apparatus for transmitting data in a mobile communication system, the apparatus comprising:
a transmission controller for, when a status report is not received after a predetermined time elapses since a polling Packet Data Unit (PDU) is initially transmitted, controlling the apparatus to generate a Radio Link Control (RLC) PDU indicating retransmission of the initially transmitted polling PDU; and
a transmitter for transmitting the RLC PDU indicating the retransmission of the initially transmitted polling PDU under a control of the transmission controller.

12. The apparatus as claimed in claim 11, wherein the transmission controller divides the initially transmitted polling PDU into a given number of segments for retransmission, sets a payload size of a segment of the divided segments to 0, and sets the segment having the payload size 0 as the RLC PDU indicating the retransmission of the initially transmitted polling PDU.

13. The apparatus as claimed in claim 12, wherein the segment having the payload size of 0 comprises a first segment or a last segment of the given number of segments.

14. The apparatus as claimed in claim 11, wherein the transmitter generates an RLC control PDU that includes information indicating a PDU for control information transmission and information indicating the retransmission of the initially transmitted polling PDU.

15. The apparatus as claimed in claim 11, wherein the transmitter generates the RLC PDU indicating the retransmission of the initially transmitted polling PDU in such a manner as to include only an RLC header.

16. An apparatus for receiving data in a mobile communication system, the apparatus comprising:
a reception controller for, when a Radio Link Control Packet Data Unit (RLC PDU) is received, determining whether the received RLC PDU is an RLC PDU indicating retransmission of an initially transmitted polling PDU; and
a status report processor for, when the received RLC PDU is determined to be the RLC PDU indicating the retransmission of the initially transmitted polling PDU, immediately generating and transmitting a reception status report.

17. The apparatus as claimed in claim 16, wherein the reception controller determines whether the received RLC PDU belongs to a given number of segments for retransmission, into which the initially transmitted polling PDU is divided, and whether a payload of a segment of the divided segments is set to 0, and determines whether the segment having the payload size of 0, is set to the RLC PDU indicating the retransmission of the initially transmitted polling PDU.

18. The apparatus as claimed in claim 17, wherein the segment having the payload size of 0 comprises a first segment or a last segment of the given number of segments.

19. The apparatus as claimed in claim 16, wherein the reception controller determines whether the received RLC PDU is an RLC control PDU that includes information indicating a PDU for control information transmission and information indicating the retransmission of the initially transmitted polling PDU.

20. The apparatus as claimed in claim 16, wherein the reception controller determines whether the received RLC PDU includes only an RLC header, and determines whether the RLC header includes information indicating the retransmission of the initially transmitted polling PDU.

21. A method of improving Automatic Repeat reQuest (ARQ) performance in a mobile communication system, the method comprising:
determining whether a predetermined time set in a polling timer has expired; and
when the predetermined timer has expired, generating a polling Packet Data Unit (PDU), the polling PDU having specific features identifying the polling PDU as a polling PDU for retransmission.

22. The method of claim 21, wherein the polling PDU is divided into a plurality of segments, and the specific feature is that at least one of the plurality of segments has a payload size of 0 bytes.

23. The method of claim 22, wherein the at least one of the plurality of segments is a first segment of the plurality of segments or a last segment of the plurality of segments.

24. The method of claim 21, wherein the specific feature is information indicating that the polling PDU is a control PDU.

25. The method of claim 21, wherein the specific feature is that the polling PDU includes only a header section.

26. A method of receiving a Packet Data Unit (PDU) in a mobile communication system, the method comprising:
receiving a PDU;
determining whether the PDU is a retransmitted polling PDU based on a specific feature of the polling PDU; and
when the PDU is determined to be a retransmitted polling PDU, immediately generating a reception status report based on the retransmitted polling PDU.

27. The method of claim 26, wherein the determining of whether the PDU is the retransmitted polling PDU comprises determining whether at least one segment of the PDU has a payload size of 0.

28. The method of claim 27, wherein the at least one segment is a first segment of the PDU or a last segment of the PDU.

29. The method of claim 26, wherein the determining of whether the PDU is a retransmitted polling PDU comprises determining whether the PDU contains information identifying the PDU as a control PDU.

30. The method of claim 26, wherein the determining of whether the PDU is a retransmitted PDU comprises determining whether the PDU contains only a header section.

31. The method of claim 30, further comprising:
when the PDU contains only a header section, removing the PDU from a reception buffer of an apparatus receiving the PDU.
